(19) United States
(12) Patent Application Publication
(10) Pub. No.: US 2006/0007373 A1
(43) Pub. Date: Jan. 12, 2006

(54) Reflective color conversion color filter and reflective display device using this filter

(75) Inventors: Koji Arai, Tokyo (JP); Koji Ishizaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: DAI NIPPON PRINTING CO., LTD., Tokyo (JP)

(21) Appl. No.: 11/109,632

(22) Filed: Apr. 20, 2005

(30) Foreign Application Priority Data
Apr. 22, 2004 (JP) 2004-126425

(51) Int. Cl. G02F 1/1335

(52) U.S. Cl. 349/113; 349/106

(57) ABSTRACT

An object is to provide a reflective color conversion color filter capable of reducing loss of outdoor daylight in reflection display, and a reflective display device using this filter, a color filter layer and a color conversion layer are stacked in this order on a reflective layer, as the color conversion layer, the color filter layer is configured to absorb a part of light of a wavelength region absorbed by the color filter layer and to convert the part into light of a wavelength region transmitted by the color filter layer, and the reflective color conversion color filter is constituted.

### BACKGROUND OF THE INVENTION

The present invention relates to a color filter for use in a display device, particularly to a reflective color conversion color filter using a color conversion layer, and a reflective display device using this reflective color conversion color filter.

Color filters have heretofore been used in color display devices such as a liquid crystal display device, an organic EL display device, and electronic paper. Examples of the conventional color filters include: a pigment dispersion type color filter in which pigment is dispersed; and a dye color filter in which a dye base is used. Especially in coloring in the reflective display device, the color filter is disposed, and color display is performed. The color filter comprises a reflective layer, and reflects incident visible light from outdoor daylight.

Moreover, there has been proposed a liquid crystal display device or an organic EL display device which does not use any color filter and which uses a color conversion layer.

Furthermore, there has been proposed a liquid crystal display device in which a light absorbing color filter is combined with the color conversion layer to enhance light use efficiency of a backlight (Japanese Patent Application Laid-Open No. 10-170918).

However, in the conventional pigment dispersion type color filter or the dye color filter, about two thirds of the incident light from the outdoor daylight is absorbed, and the remaining one third only is transmitted and reflected for use in the color display. Therefore, there has been a problem that the display is darkened.

Moreover, when the color conversion layer is used in the transmission type liquid crystal display device or the organic EL display device, a large amount of current is consumed, and therefore the layer is not suitable for long-time use as in mobile application or the like in some case.

Furthermore, in the liquid crystal display device described in the Patent Document 1 (Japanese Patent Application Laid-Open No. 10-170918), the use efficiency of transmission light from the backlight is enhanced. However, in reflection display, there has been a problem that about two thirds of the incident light from the outdoor daylight are absorbed by the color filter, and the display is darkened.

### DISCLOSURE OF THE INVENTION

An object of the present invention is to provide a reflective color conversion color filter capable of reducing loss of outdoor daylight in reflection display, and a reflective display device using this filter.

To achieve this object, according to the present invention, there is provided a reflective color conversion color filter comprising: at least a reflective layer; and a color filter layer and a color conversion layer successively stacked on the reflective layer, the color conversion layer being configured to absorb a part of light of a wavelength region absorbed by the color filter layer and to convert the part into light of a wavelength region transmitted by the color filter layer.

In another mode of the present invention, the color filter layer comprises at least one of a red color filter layer which transmits light of a red wavelength region, a green color filter layer which transmits light of a green wavelength region, and a blue color filter layer which transmits light of a blue wavelength region. The color conversion layer disposed in the red color filter layer is a red conversion layer which absorbs light on a wavelength side shorter than red light and which converts the light into light containing a red component; the color conversion layer disposed in the green color filter layer is a green conversion layer which absorbs light on a wavelength side shorter than green light and which converts the light into light containing a green component; and the color conversion layer disposed in the blue color filter layer is a blue conversion layer which absorbs light on a wavelength side shorter than blue light and which converts the light into light containing a blue component.

In another mode of the present invention, the red color filter layer has an average light ray transmission ratio of 10% or less in a wavelength range of 400 to 550 nm, the green color filter layer has an average light ray transmission ratio of 10% or less in a wavelength range of 400 to 450 nm, and an average light ray transmission ratio of 20% or less in a wavelength range of 600 to 700 nm, and the blue color filter layer has an average light ray transmission ratio of 10% or less in a wavelength range of 550 to 700 nm.

In another mode of the present invention, the reflective layer is formed into a concave/convex shape on an interface between the reflective layer and the color filter layer, and the reflective layer is constituted as a white plate.

In another mode of the present invention, the color filter layer and the color conversion layer are stacked on the reflective layer for each pixel, a gap portion is disposed between the pixels, and the gap portion is provided with a black matrix.

According to the present invention, there is provided a reflective display device comprising: a first substrate; a second substrate which faces the first substrate and which is positioned on an observer side; any of the above-described reflective color conversion color filters disposed in such a manner that the reflective layer side is positioned on the surface of the first substrate facing the second substrate; a liquid crystal layer which is disposed between the reflective color conversion color filter and the second substrate to change an oriented state in accordance with an applied voltage; and a pair of polarization layers disposed on first and second substrate sides of the liquid crystal layer.

In another mode of the present invention, the polarization layer disposed on the first substrate side is disposed between the liquid crystal layer and the reflective color conversion color filter.

According to the present invention, there is provided a reflective display device comprising: a first substrate; a second substrate which faces the first substrate and which is positioned on an observer side; any of the above-described reflective color conversion color filters disposed in such a manner that the reflective layer side is positioned on the surface of the first substrate facing the second substrate; and a transparent insulating liquid layer disposed between the reflective color conversion color filter and the second substrate and containing particles whose distributed states change in accordance with an applied voltage.

According to the present invention described above, the color conversion layer is positioned on the observer side from the color filter layer with respect to the reflective layer, and converts outdoor daylight into light of a wavelength region capable of passing through the color filter layer. Therefore, use efficiency of the outdoor daylight is enhanced. In the reflective display device using the reflective color conversion color filter of the present invention, color display is possible which is bright and whose color reproduction range is broad.

### BRIEF DESCRIPTION OF THE DRAWINGS

FIG. 1 is a schematic sectional view showing one embodiment of a reflective color conversion color filter of the present invention;

FIG. 2 is a schematic sectional view showing another embodiment of the reflective color conversion color filter of the present invention;

FIG. 3 is a schematic sectional view showing another embodiment of the reflective color conversion color filter of the present invention;

FIG. 4 is a schematic sectional view showing another embodiment of the reflective color conversion color filter of the present invention;

FIG. 5 is a schematic sectional view showing another embodiment of the reflective color conversion color filter of the present invention;

FIG. 6 is a schematic sectional view showing one embodiment of a reflective display device of the present invention; and

FIG. 7 is a schematic sectional view showing another embodiment of the reflective display device of the present invention.

### DESCRIPTION OF PREFERABLE EMBODIMENT

Embodiments of the present invention will be described hereinafter with reference to the drawings.

[Reflective Color Conversion Color Filter]

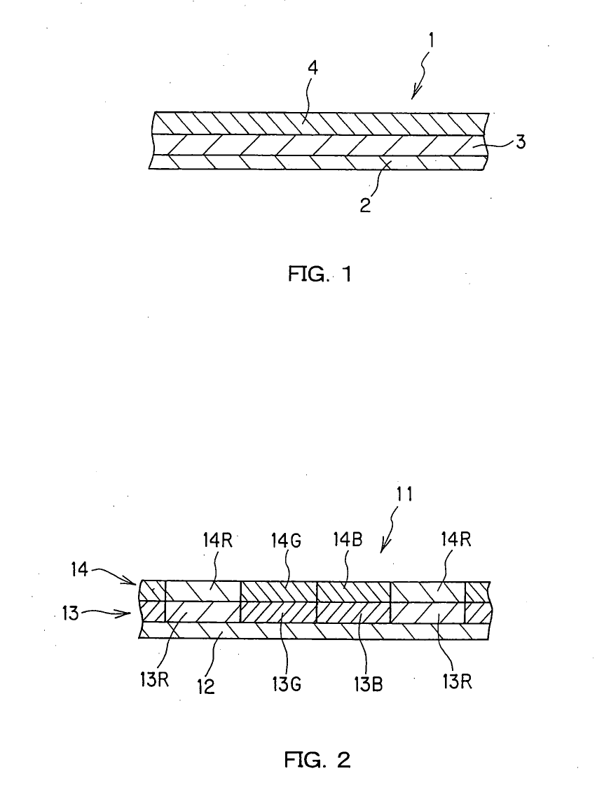

FIG. 1 is a schematic sectional view showing one embodiment of a reflective color conversion color filter of the present invention. In FIG. 1, a reflective color conversion color filter 1 of the present invention comprises: a reflective layer 2; and a color filter layer 3 and a color conversion layer 4 successively stacked on the reflective layer 2. This color conversion layer 4 absorbs a part of light of a wavelength region absorbed by the color filter layer 3, and converts the light into light of a wavelength region transmitted through the color filter layer 3.

Moreover, FIG. 2 is a schematic sectional view showing another embodiment of the reflective color conversion color filter of the present invention. In FIG. 2, a reflective color conversion color filter 11 of the present invention comprises: a reflective layer 12; and a color filter layer 13 and a color conversion layer 14 successively stacked on the reflective layer 12.

As to the color filter layer 13, layers are disposed in predetermined pattern shapes: a red color filter layer 13R which transmits light of a red wavelength region; a green color filter layer 13G which transmits light of a green wavelength region; and a blue color filter layer 13B which transmits light of a blue wavelength region. The color conversion layer 14 stacked on these respective color filter layers 13R, 13G, 13B is constituted of a red conversion layer 14R, a green conversion layer 14G, and a blue conversion layer 14B. Moreover, the red conversion layer 14R disposed on the red color filter layer 13R is a color conversion layer which absorbs light on a wavelength side shorter than red light and which converts the light into light containing a red component. The green conversion layer 14G disposed on the green color filter layer 13G is a color conversion layer which absorbs light on the wavelength side shorter than green light and which converts the light into light containing a green component. The blue conversion layer 14B disposed on the blue color filter layer 13B is a color conversion layer which absorbs light on the wavelength side shorter than blue light and which converts the light into light containing a blue component.

The reflective layers 2, 12 constituting the reflective color conversion color filters 1, 11 can be formed into dielectric multilayered films of metals and alloys such as aluminum, silver, and silver alloy, metal oxide, metal nitride, metal fluoride and the like. These reflective layers 2, 12 can be formed by known film forming means such as a vacuum evaporation method and a sputtering method, and thickness is set to about 0.05 to 1 μm. As the reflective layers 2, 12, white plates may be used such as tetrafluoroethylene, a resin film in which light scattering particles are dispersed, and a resin plate on whose surface irregularities are formed and which is coated with a metal layer. The thickness of the white plate can be appropriately set, for example, in a range of 25 to 1000 μm. When the white plates are used as the reflective layers 2, 12, complete scattering can be caused, and view field angles of the reflective color conversion color filters 1, 11 can be enlarged.

The color filter layers 3, 13 constituting the reflective color conversion color filters 1, 11 can be formed by a known pigment dispersing method, a dyeing method, an electrodeposition method or the like, and the thickness can be set, for example, to about 1 to 2 μm. The respective color filter layers 13R, 13G, 13B constituting the color filter layer 13 can be disposed, for example, in a stripe form, a mosaic form, a triangle form, a four pixel disposition shape or the like. The red color filter layer 13R preferably has an average light ray transmission ratio of 10% or less in a wavelength range of 400 to 550 nm, the green color filter layer 13G has an average light ray transmission ratio of 10% or less in a wavelength range of 400 to 450 nm, and an average light ray transmission ratio of 20% or less in a wavelength range of 600 to 700 nm, and the blue color filter layer 13B has an average light ray transmission ratio of 10% or less in a wavelength range of 550 to 700 nm.

The color conversion layers 4, 14 constituting the reflective color conversion color filters 1, 11 absorb a part of outdoor daylight including ultraviolet rays, convert the part into predetermined low-energy light (long wavelength light), and utilizes Stokes shift law of a fluorescent material. These color conversion layers 4, 14 can effectively utilize unnecessary light that enters the reflective color conversion color filter, and can enhance use efficiency of outdoor daylight. The color conversion layers 4, 14 can effectively reduce light (unnecessary light) of a component which cannot be absorbed by the color filter layer, and also have a function of broadening a color reproduction range.

The color conversion layers 4, 14 are layers constituted of a single fluorescent material, or layers containing the fluorescent material in a resin. Examples of a red conversion fluorescent material for use in the red conversion layer 14R include: a cyanine-based dyestuff such as 4-dicyanomethylene-2-methyl-6-(p-dimethylaminostyryl)-4H-pyran; a pyridine dyestuff such as 1-ethyl-2-[4-p-dimethylaminophenyl]-1,3-butadienyl]-pyridium-perchlorate; a rhodamine-based dyestuff such as rhodamine B and rhodamine 6G; an oxazine-based dyestuff and the like.

Moreover, examples of a green conversion fluorescent material for use in the green conversion layer 14G include: a coumarin dyestuff such as 2,3,5,6-1H, 4H-tetrahydro-8-trifluoromethylquinolidino(9,9a,1-gh)coumarin, 3-(2′-benzothiazolyl)-7-diethylaminocoumarin, 3-(2′-benzoimidazolyl)-7-N, N-diethylaminocoumarin; a coumarin dyestuff-based dye such as basic yellow 51; a naphthalimide dyestuff such as solvent yellow-11 and solvent yellow-116 and the like.

Furthermore, examples of a blue conversion fluorescent material for use in the blue conversion layer 14B include: a stilbene-based dyestuff such as 1,4-bis(2-methylstyryl)benzene, trans-4,4′-diphenylstilbene; a coumarin dyestuff such as 7-hydroxy-4-methylcoumarin and the like.

Furthermore, various types of dyes are usable such as a direct dye, an acid dye, a basic dye, and a disperse dye as long as the dyes have fluorescent properties. The above-described fluorescent materials are usable alone or in a combination of two or more of them.

When the color conversion layers 4, 14 contain a desired fluorescent material in a resin, a content of the fluorescent material can be appropriately set in consideration of a fluorescent material for use, thickness of the color conversion layer and the like, and can be set, for example, to about 0.1 to 5 weight % with respect to the resin for use. As the resin for use, transparent (visible light transmission ratio of 50% or more) resin are usable such as polymethylmethacrylate, polyacrylate, polycarbonate, polyvinyl alcohol, polyvinyl pyrrolidone, hydroxyethyl cellulose, carboxymethyl cellulose, polyvinylchloride resin, melamine resin, phenol resin, alkyd resin, epoxy resin, polyurethane resin, polyester resin, maleic acid resin, and polyamide resin. When patterns of the color conversion layers 14R, 14G, 14B are formed by a photolithography method, an ionization radiation hardening resin (e.g., an electron ray hardening resin or an ultraviolet hardening resin) is usable which has a reactive vinyl group such as a polycinnamate vinyl base and cyclic rubber base. If necessary, an acrylic acid or methacrylic acid component is contained in copolymer, an alkali developing property can be imparted.

The color conversion layers 4, 14 are formed by the photolithography process in this manner. Additionally, with respect to the above-described color conversion fluorescent materials of the respective colors and the resins, if necessary, an appropriate amount of additive is added such as solvent, diluent such as reactive monomer, photo reaction or thermal reaction starting agent, developing auxiliary agent, and adhesive enhancing agent, and an ink composition may be prepared and printed to form the layers. The thickness of each of the color conversion layers 4, 14 needs to be set in such a manner that it is possible to develop a function of absorbing a part of outdoor daylight including an ultraviolet ray and converting the part into predetermined low-energy light (long wavelength light). The thickness can be appropriately set in consideration of the fluorescent material for use, fluorescent material concentration or the like, and can be set, for example, to about 5 to 20 μm.

It is to be noted that instead of the blue conversion layer 14B, the transparent resin layer may be formed. The transparent resin layer may be formed by a photolithography process. A transparent resin layer may be formed, which replaces the blue conversion layer 14B, by the printing using the above-described ink composition from which the color conversion fluorescent material has been removed.

Moreover, in the present invention, on a substrate, the reflective color conversion color filters 1, 11 may be disposed which are constituted of the above-described reflective layers 2, 12, color filter layers 3, 13, and color conversion layers 4, 14. In this case, as the substrate, a substrate which does not have any flexibility is usable such as glass, quartz glass, heat-resistant glass, and synthetic quartz plate. A substrate having flexibility is also usable such as: a resin film such as a polyethylene terephthalate resin, polycarbonate resin, polyimide resin, polystyrene resin, polyethylene resin, polyethersulfone resin, polyarylate resin, acryl resin, cellulose resin, epoxy resin, cyclic olefin resin, and cyclic olefin copolymer resin; an optical resin plate and the like.

Surface smoothness is preferably high on the surface of the substrate on which the reflective color conversion color filters 1, 11 are formed, and an average surface roughness Ra is preferably, for example, 0.5 to 3.0 nm (measured in a 5 μm square region). On a surface opposite to the surface of the substrate on which the reflective color conversion color filters 1, 11 are formed, if necessary, layers can be directly formed such as a hard coating layer for preventing scratches, a charging preventive layer, a contamination preventive layer, and a dazzling preventive layer. Alternatively, necessary layers of the above-described layers may be formed on transparent films, and the films may be laminated and disposed. Furthermore, a function of a touch panel or the like may be added.

It is to be noted that to dispose the reflective color conversion color filters 1, 11 on the above-described substrate, when the substrate is positioned on a color conversion layer 4, 14 side (positioned on an observer side), a transparent substrate is preferably used.

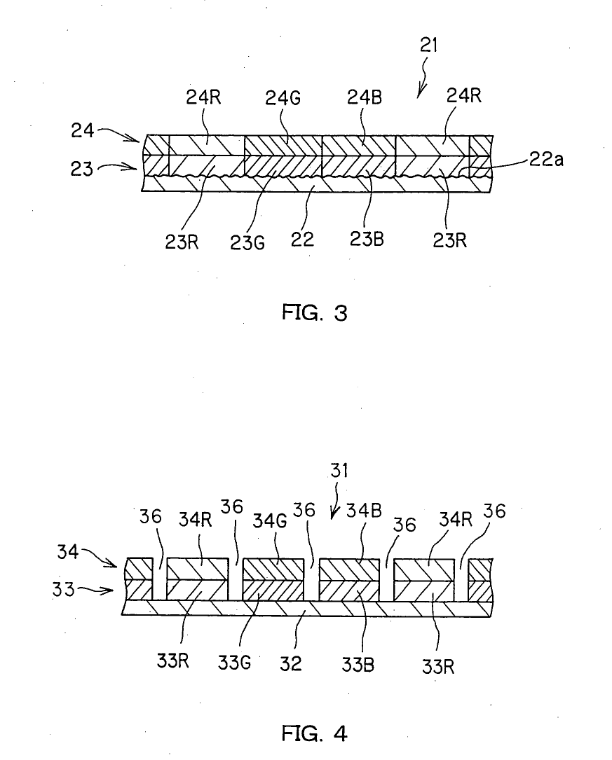

FIG. 3 is a schematic sectional view showing another embodiment of the reflective color conversion color filter of the present invention. In FIG. 3, a reflective color conversion color filter 21 of the present invention comprises: a reflective layer 22; and a color filter layer 23 and a color conversion layer 24 successively stacked on the reflective layer 22.

This reflective color conversion color filter 21 is the same as the above-described reflective color conversion color filter 11 except that the reflective layer 22 has a concave/convex shape in an interface 22a with the color filter layer 23.

In the reflective layer 22, irregularities are directly formed on the reflective layer constituted of a metal, alloy, dielectric multilayered film or the like in the same manner as in the above-described reflective layers 2, 12, or the reflective layer is coated with a resin layer to form the irregularities on the resin layer. As a method of directly forming the irregularities on the reflective layer, examples include sand blasting, chemical etching and the like. In a case where irregularities are formed using the resin layer, a thermal pressure is applied to a thermal plastic resin to shape the resin, or a thermal hardening resin or an ultraviolet hardening resin may be used and shaped. As to the concave/convex shape to be formed, an average surface roughness Ra is preferably in a range of 0.02 to 0.3 μm.

When the reflective layer 22 having the concave/convex shape is disposed in this manner, a reflective color conversion color filter can be obtained whose view field angle has been enhanced.

As to the color filter layer 23 constituting the reflective color conversion color filter 21, layers are disposed in predetermined pattern shapes: a red color filter layer 23R; a green color filter layer 23G; and a blue color filter layer 23B, and they can be formed in the same manner as in the above-described color filter layer 13. The color conversion layer 24 is stacked on these respective color filter layers 23R, 23G, 23B, and constituted of a red conversion layer 24R, a green conversion layer 24G, and a blue conversion layer 24B. They can be formed in the same manner as in the color conversion layer 14 of the above-described embodiment.

FIG. 4 is a schematic sectional view showing another embodiment of the reflective color conversion color filter of the present invention. In FIG. 4, a reflective color conversion color filter 31 of the present invention comprises: a reflective layer 32; and a color filter layer 33 and a color conversion layer 34 successively stacked on the reflective layer 32.

The reflective color conversion color filter 31 is the same as the above-described reflective color conversion color filter 11 in that the filter 31 has a color filter layer 33 in which a red color filter layer 33R, green color filter layer 33G, and blue color filter layer 33B are disposed in predetermined pattern shapes for each pixel, and on these respective color filter layers 33R, 33G, 33B, the color conversion layer 34 is stacked which is constituted of a red conversion layer 34R, a green conversion layer 34G, and a blue conversion layer 34B. The filter 31 differs in that a laminate of each color filter layer and color conversion layer is disposed for each pixel with a gap portion 36 (portion in which either the color filter layer or the color conversion layer is not formed). When this gap portion 36 is disposed between the respective pixels, a color reproduction range slightly drops, but a brighter reflective color conversion color filter is possible. A width of the gap portion 36 can be set, for example, to a range of 2 to 50 μm.

The reflective layer 32 can be formed in the same manner as in the reflective layers 2, 12 of the above-described embodiments. The layer may be provided with a concave/convex shape in the same manner as in the reflective layer 22 of the above-described embodiment.

The color filter layer 33 comprising the red color filter layer 33R, green color filter layer 23G, and blue color filter layer 33B, and the color conversion layer 34 comprising the red conversion layer 34R, green conversion layer 34G, and blue conversion layer 34B can be formed in the same manner as in the color filter layer 13 and the color conversion layer 14 of the above-described embodiment.

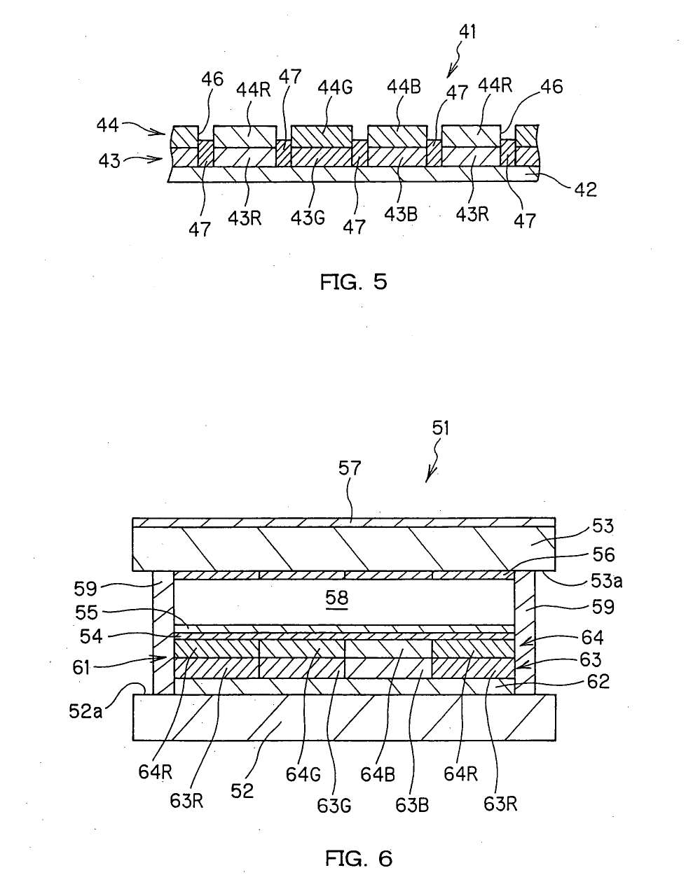

FIG. 5 is a schematic sectional view showing another embodiment of the reflective color conversion color filter of the present invention. In FIG. 5, a reflective color conversion color filter 41 of the present invention comprises: a reflective layer 42; and a color filter layer 43 and a color conversion layer 44 successively stacked on the reflective layer 42.

This reflective color conversion color filter 41 has a color filter layer 43 in which a red color filter layer 43R, green color filter layer 43G, and blue color filter layer 43B are disposed in predetermined pattern shapes for each pixel, and on these respective color filter layers 43R, 43G, 43B, the color conversion layer 44 is stacked which is constituted of a red conversion layer 44R, a green conversion layer 44G, and a blue conversion layer 44B. A laminate of the color filter layer and color conversion layer is disposed for each pixel with a gap portion 46 (portion in which either the color filter layer or the color conversion layer is not formed). A black matrix 47 is formed in this gap portion 46. When the black matrix 47 is disposed between the respective pixels in this manner, a reflective color conversion color filter is possible in which prevents reflection of outdoor daylight in a boundary of each pixel, or nullifying and which has high image or video contrast. It is to be noted that a width of the black matrix 47 (gap portion 46) can be set, for example, to a range of 5 to 50 μm.

The black matrix 47 can be formed into a thin film of a metal, metal oxide, metal nitride or and the like, or a thin film of a combination of them, for example, a stacked film of CrOₓ/Cr (x is an arbitrary number), a stacked film of CrOₓ/CrN_{y}/Cr (x, y are arbitrary numbers) or the like. The film can be formed by a known vacuum film forming process such as an evaporation process, ion plating process, and sputtering process. Especially, when considering an optical concentration which can be sufficiently shielded, resistance to cleaning, processing property and the like, a thin film containing metal chromium is most preferable. To form the pattern of the black matrix after forming the thin film having the shielding property, a photolithography process or the like is usable. For example, the formed thin film is coated with a photo resist, exposed via a pattern mask, and developed to form a resist pattern. Thereafter, the black matrix can be formed through steps of etching and cleaning. The black matrix 47 may be formed by an electroless plating process, a printing process using a black ink composition or the like. A thickness of the black matrix 47 can be set to about 0.2 to 0.4 μm in the thin film by the vacuum film forming process, or electroless plating process, and can be set to about 0.5 to 2 μm in a case where the matrix is formed by the printing process.

The reflective layer 42 can be formed in the same manner as in the reflective layers 2, 12 of the above-described embodiments. The layer may be provided with a concave/convex shape in the same manner as in the reflective layer 22 of the above-described embodiment.

The color filter layer 43 comprising the red color filter layer 43R, green color filter layer 43G, and blue color filter layer 43B, and the color conversion layer 44 comprising the red conversion layer 44R, green conversion layer 44G, and blue conversion layer 44B can be formed in the same manner as in the color filter 13 and the color conversion layer 14 of the above-described embodiment.

[Reflective Display Device]

Next, a reflective display device of the present invention will be described.

FIG. 6 is a schematic sectional view showing one embodiment of the reflective display device of the present invention. In FIG. 6, a reflective display device 51 of the present invention comprises: a first substrate 52; a second substrate 53 which faces the first substrate 52 and which is positioned on an observer side; a reflective color conversion color filter 61 disposed on a surface 52a of the first substrate 52 facing the second substrate; a common transparent electrode 54 and a polarization layer 55 stacked on the reflective color conversion color filter 61; a driving element layer 56 disposed on a surface 53a of the second substrate 53 facing the first substrate; a polarization layer 57 disposed on an opposite surface of the second substrate 53; and a liquid crystal layer 58 which is sealed between the reflective color conversion color filter 61 and the second substrate 53 of a space sealed by the first substrate 52, second substrate 53, and sealing member 59, and whose oriented state is changed in accordance with an applied voltage.

The reflective color conversion color filter 61 constituting the above-described reflective display device 51 has a structure similar to that of the reflective color conversion color filter 11 of the above-described invention. The filter comprises: a reflective layer 62; and a color filter layer 63 and a color conversion layer 64 successively stacked on this reflective layer 62, and the reflective layer 62 is allowed to abut on the first substrate 52. That is, the reflective color conversion color filter 61 has the color filter layer 63 in which a red color filter layer 63R, green color filter layer 63G, and blue color filter layer 63B are disposed in predetermined pattern shapes for each pixel, and on these respective color filter layers 63R, 63G, 63B, the color conversion layer 64 is stacked which is constituted of a red conversion layer 64R, a green conversion layer 64G, and a blue conversion layer 64B. Each constituting member of this reflective color conversion color filter 61 is similar to that of the reflective color conversion color filter 11 of the above-described invention, and description is omitted here.

As the first substrate 52 and the second substrate 53 constituting the above-described reflective display device 51, a substrate which does not have any flexibility is usable such as glass, quartz glass, heat-resistant glass, and synthetic quartz plate. A substrate having flexibility is also usable such as: a resin film such as a polyethylene terephthalate resin, polycarbonate resin, polyimide resin, polystyrene resin, polyethylene resin, polyethersulfone resin, polyarylate resin, acryl resin, cellulose resin, epoxy resin, cyclic olefin resin, and cyclic olefin copolymer resin; an optical resin plate and the like. Additionally, a material having a high light transmitting property is used in the second substrate 53 which is positioned on the observer side.

It is to be noted that surface smoothness is preferably high on the surface of the first substrate 52 on which the reflective color conversion color filter 61 is formed, and an average surface roughness Ra is preferably, for example, 0.5 to 3.0 nm (measured in a 5 μm square region). On a surface opposite to the surface of the substrate 52 on which the reflective color conversion color filter is formed, if necessary, layers can be directly formed such as a hard coating layer for preventing scratches, a charging preventive layer, a contamination preventive layer, and a dazzling preventive layer. Alternatively, necessary layers of the above-described layers may be formed on transparent films, and the films may be laminated and disposed. Furthermore, a function of a touch panel or the like may be added.

The common transparent electrode 54 constituting the reflective display device 51 of the present invention can be formed into a thin film of indium tin oxide (ITO), zinc oxide (ZnO), tin oxide (SnO) or the like, the film can be formed by general film forming methods such as a sputtering process, vacuum evaporation process, and CVD process, and a thickness is preferably about 0.01 to 1 μm. In the driving element layer 56, for example, a plurality of thin film transistors (TFT) and transparent pixel electrodes are arranged via scanning lines and signal lines.

In the reflective display device 51 of the present invention, since there is not any polarization in the light color-converted by the color conversion layer 64 of the reflective color conversion color filter 61, the polarization layer 55 is preferably disposed in a position where polarization occurs after the color conversion. In a shown example, the polarization layer 55 is disposed between the reflective color conversion color filter 61 and the liquid crystal layer 58. The polarization layers 55, 57 may be either an applied/formed polarization layer or a polarization plate, and the polarization layer 55 formed in a liquid crystal cell is preferably applied/formed polarization layer. This polarization layer of this applied type can be formed, for example, using a commercially available material manufactured by Optiva Co., or may be formed using polymeric liquid crystal in which a single or a plurality of dichroic dyestuffs are dispersed. As the polarization plate, a polarization plate is usable which has heretofore been used in a liquid crystal display device.

The liquid crystal layer 58 constituting the reflective display device 51 of the present invention has a function of a switching layer. As long as optical switching is possible in the liquid crystal, there is not any special limitation as to an operation mode, and a liquid crystal of any operation mode may be used such as twisted nematic (TN), super twisted nematic (STN), vertically aligned (VA), in-plane switching (IPS), and optically compensated bend (OCB). Various types of view field angle compensation films may be combined for use. In the shown example, the common transparent electrode 54 and the driving element layer 56 are disposed in such a manner as to hold the liquid crystal layer 58 therebetween, but the electrode or the driving element may be disposed in accordance with the operation mode of the liquid crystal layer 58, and the present invention is not limited to the shown example.

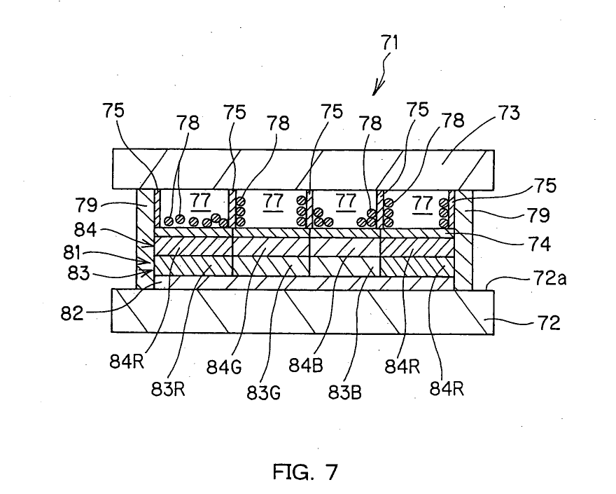

FIG. 7 is a schematic sectional view showing another embodiment of the reflective display device of the present invention. In FIG. 7, a reflective display device 71 of the present invention comprises: a first substrate 72; a second substrate 73 which faces the first substrate 72 and which is positioned on an observer side; a reflective color conversion color filter 81 and a driving element layer 74 disposed on a surface 72a of the first substrate 72 facing the second substrate; an electrode 75 which also serves as a partition wall for dividing a space sealed by the first substrate 72, second substrate 73, and sealing member 79 into red, green, blue pixels; and a transparent insulating liquid layer 77 with which the space of each pixel is charged. The transparent insulating liquid layer 77 contains (charged/migrating) particles 78 whose distributed states change in accordance with voltages applied to the driving element layer 74 and the electrode 75.

The reflective color conversion color filter 81 constituting the above-described reflective display device 71 comprises: a reflective layer 82; and a color filter layer 83 in which a red color filter layer 83R, a green color filter layer 83G, and a blue color filter layer 83B are disposed in predetermined pattern shapes for each pixel. On these respective color filter layers 83R, 83G, 83B, a color conversion layer 84 is stacked which is constituted of a red conversion layer 84R, a green conversion layer 84G, and a blue conversion layer 84B.

It is to be noted that the reflective layer 82 can be formed in the same manner as in the reflective layers 2, 12 of the reflective color conversion color filters 1, 11 of the above-described invention, and the layer may comprise a concave/convex shape in the same manner as in the reflective layer 22 of the above-described reflective color conversion color filter 22. The color filter layer 83 constituted of the red color filter layer 83R, green color filter layer 83G, and blue color filter layer 83B, and the color conversion layer 84 constituted of the red conversion layer 84R, green conversion layer 84G, and blue conversion layer 84B can be formed in the same manner as in the color filter layer 13, color conversion layer 14 of the reflective color conversion color filter 11 of the above-described invention, and description is omitted here.

The above-described driving element layer 74 may comprise, for example, a plurality of transparent pixel electrodes and thin film transistors (TFT) disposed corresponding to the respective pixels, and scanning lines and signal lines connecting the respective TFTs.

Moreover, the electrode 75 which also serves as the partition wall is disposed in such a manner as to be positioned in a boundary portion of a laminate of the color filter layer and the color conversion layer constituting each pixel. The electrode 75 can be formed into a conducting thin film, the conducting thin film can be formed by a vacuum film forming process or an electro-plating process. The surface of the electrode 75 may be coated with a resin material, or provided with an insulating layer on the surface by anodization. It is to be noted that the electrode 75 is not limited to the shown example, and may constitute a part of the partition wall (the part of the partition wall disposed in the vicinity of the reflective color conversion color filter 81) or may be embedded in the partition wall.

In the transparent insulating liquid layer 77, the particles 78 having charged migrating properties are dispersed in the transparent insulating liquid. As the insulating liquid, transparent non-polarity solvents are usable such as silicon oil, isoparaffin, xylene, and toluene. As the particles 78, various types of inorganic pigments, organic pigments, carbon black, resin particles containing them and the like are usable. Thus, by the use of black particles as the particles 78, the color of each pixel, black, and intermediate gradation can be displayed in accordance with the changes of the distributed states of the black particles 78.

As the first substrate 72, second substrate 73 constituting the above-described reflective display device 71, substrates are usable which are similar to the first substrate 52, second substrate 53 constituting the above-described reflective display device 51.

It is to be noted that the above-described reflective display devices 51, 71 are illustrated, and the reflective display device using the reflective color conversion color filter of the present invention is not limited to them.

Moreover, in the respective drawings showing the above-described reflective color conversion color filter and reflective display device, for ease of understanding of the constitution, the thickness of each layer, the number of pixels, dimensions and the like are described in a convenient manner.

Next, the present invention will be described in more detail with reference to more concrete examples.

### EXAMPLE

Forming of Black Matrix

As a transparent substrate, a non-alkali glass substrate (1737 manufactured by Coning Co.) was prepared which had a thickness of 0.7 mm. After washing this transparent substrate in accordance with the law, a stacked film (thickness of 0.15 μm) of CrOₓ/Cr (x is 0.8) was formed on the whole surface of the transparent substrate on one side by a sputtering process. The stacked film was coated with a photosensitive resist, mask-exposed, and developed, thereby a resist pattern was formed. A chromium thin film was etched using the resist pattern as a mask, and a black matrix was formed which comprised 70 μm×250 μm rectangular openings arranged at a pitch of 100 μm in a matrix form.

Forming of Color Filter Layer

Next, color filter layers of colors were formed using the following three types of photosensitive coatings for the color filter layers. That is, by a spin coating process, a photosensitive coating for a red color filter layer was applied to the whole surface of the above-described transparent substrate in which the black matrix was formed, and pre-baked (90° C., 3 minutes). Thereafter, the layers were exposed using a predetermined photo mask. Next, the layers were developed in a developing solution (0.05% KOH aqueous solution). Next, post baking (200° C., 30 minutes) was performed, and a band-shaped (width of 90 μm) red color filter layer (thickness of 1.2 μm) was formed in a predetermined position with respect to the black matrix pattern.

Similarly, a band-shaped (width of 90 μm) green color filter layer (thickness of 1.2 μm) was formed in a predetermined position with respect to the black matrix pattern using a photosensitive coating of the green color filter layer. Furthermore, a band-shaped (width of 90 μm) blue color filter layer (thickness of 1.2 μm) was formed in a predetermined position with respect to the black matrix pattern using a photosensitive coating of the blue color filter layer.

(Red Color Filter Layer Photosensitive Coating)

An acrylic ester-based photo hardening resist (V-259PA/PH5 manufactured by Nippon Steel Chemical Co., Ltd., solid content concentration: 50%) was used as a binder resin, this binder resin was blended with a condensed azoic pigment (Chromophthal Red BRN manufactured by Chiba Gaigi Co.) which was a red coloring agent at a ratio of 30% in a total solid content, and they were sufficiently mixed/dispersed to form a red color filter layer photosensitive coating.

(Green Color Filter Layer Photosensitive Coating)

An acrylic ester-based photo hardening resist (V-259PA/PH5 manufactured by Nippon Steel Chemical Co., Ltd., solid content concentration: 50%) was used as a binder resin, this binder resin was blended with a phthalocyanine-based green pigment (Rionol Green 2Y-301 manufactured by Toyo Ink Mfg. Co., Ltd.) which was a green coloring agent at a ratio of 60% in a total solid content, and they were sufficiently mixed/dispersed to form a green color filter layer photosensitive coating.

(Blue Color Filter Layer Photosensitive Coating)

An acrylic ester-based photo hardening resist (V-259PA/PH5 manufactured by Nippon Steel Chemical Co., Ltd., solid content concentration: 50%) was used as a binder resin, this binder resin was blended with an anthraquinone-based pigment (Chromophthal Blue A3R manufactured by Chiba Gaigi Co., Ltd.) which was a blue coloring agent at a ratio of 20% in a total solid content, and they were sufficiently mixed/dispersed to form a blue color filter layer photosensitive coating.

As a result of measuring of an average light ray transmission ratio of the above-described color filter of each color by the following method, the average light ray transmission ratio of the red color filter layer was 6% in a wavelength range of 400 to 550 nm, and the average light ray transmission ratio of the green color filter layer was 6% in a wavelength range of 400 to 450 nm, and the average light ray transmission ratio was 13% in a wavelength range of 600 to 700 nm. The average light ray transmission ratio of the blue color filter layer was 8% in a wavelength range of 550 to 700 nm.

(Method of Measuring Average Light Ray Transmission Ratio)

The ratio was measured via a pinhole in a range smaller than that of an opening of a colored pixel using a microscopic spectrophotometer manufactured by Olympus Optical Co., Ltd.

Forming of Color Conversion Layer

Next, the following coating liquid for a red conversion layer, coating liquid for a green conversion layer, and coating liquid for a blue conversion layer were prepared. Next, a band-shaped pattern was printed on the red color filter layer by a screen printing process using the coating liquid for the red conversion layer, and was baked (200° C., 60 minutes). Accordingly, the band-shaped (width of 85 μm) red conversion layer (thickness of 10 μm) was formed on the red color filter layer.

Next, a band-shaped pattern was printed on the green color filter layer by the screen printing process using the coating liquid for the green conversion layer, and was baked (200° C., 60 minutes). Accordingly, the band-shaped (width of 85 μm) green conversion layer (thickness of 10 μm) was formed on the green color filter layer. Similarly, the band-shaped (width of 85 μm) blue conversion layer (thickness of 10 μm) was formed on the blue color filter layer using the coating liquid for the blue conversion layer.

As described above, the color conversion layer was formed comprising the red conversion layer, green conversion layer, and blue conversion layer, and a reflective color conversion color filter of the present invention was obtained.

(Coating Liquid for Red Conversion Layer)

An acrylic ester-based photo hardening resist (V-259PA/PH5 manufactured by Nippon Steel Chemical Co., Ltd., solid content concentration: 50%) was used as a binder resin, this binder resin was blended with coumarin 6, rhodamine 6G, and rhodamine B in order at ratios of 0.03 mol/kg, 1%, 1% in a total solid content, polypropylene glycol monomethyl ether acetate was used as a solvent, and the resin was diluted in such a manner as to obtain a solid content of 45% to prepare a coating liquid for the red conversion layer.

(Coating Liquid for Green Conversion Layer)

An acrylic ester-based photo hardening resist (V-259PA/PH5 manufactured by Nippon Steel Chemical Co., Ltd., solid content concentration: 50%) was used as a binder resin, this binder resin was blended with basic yellow 51 at a ratio of 1% in a total solid content, polypropylene glycol monomethyl ether acetate was used as a solvent, and the resin was diluted in such a manner as to obtain a solid content of 45% to prepare a coating liquid for the green conversion layer.

(Coating Liquid for Blue Conversion Layer)

An acrylic ester-based photo hardening resist (V-259PA/PH5 manufactured by Nippon Steel Chemical Co., Ltd., solid content concentration: 50%) was used as a binder resin, this binder resin was blended with coumarin 4 at a ratio of 1% in a total solid content, polypropylene glycol monomethyl ether acetate was used as a solvent, and the resin was diluted in such a manner as to obtain a solid content of 45% to prepare a coating liquid for the blue conversion layer.

1. A reflective color conversion color filter comprising: at least a reflective layer; and a color filter layer and a color conversion layer successively stacked on the reflective layer, the color conversion layer being configured to absorb a part of light of a wavelength region absorbed by the color filter layer and to convert the part into light of a wavelength region transmitted by the color filter layer.

2. The reflective color conversion color filter according to claim 1, wherein the color filter layer comprises at least one of a red color filter layer which transmits light of a red wavelength region, a green color filter layer which transmits light of a green wavelength region, and a blue color filter layer which transmits light of a blue wavelength region; the color conversion layer disposed in the red color filter layer is a red conversion layer which absorbs light on a wavelength side shorter than red light and which converts the light into light containing a red component; the color conversion layer disposed in the green color filter layer is a green conversion layer which absorbs light on a wavelength side shorter than green light and which converts the light into light containing a green component; and the color conversion layer disposed in the blue color filter layer is a blue conversion layer which absorbs light on a wavelength side shorter than blue light and which converts the light into light containing a blue component.

3. The reflective color conversion color filter according to claim 1, wherein the red color filter layer has an average light ray transmission ratio of 10% or less in a wavelength range of 400 to 550 nm, the green color filter layer has an average light ray transmission ratio of 10% or less in a wavelength range of 400 to 450 nm, and an average light ray transmission ratio of 20% or less in a wavelength range of 600 to 700 nm, and the blue color filter layer has an average light ray transmission ratio of 10% or less in a wavelength range of 550 to 700 nm.

4. The reflective color conversion color filter according to claim 1, wherein the reflective layer is formed into a concave/convex shape on an interface between the reflective layer and the color filter layer.

5. The reflective color conversion color filter according to claim 1, wherein the reflective layer is a white plate.

6. The reflective color conversion color filter according to claim 1, wherein the color filter layer and the color conversion layer are stacked on the reflective layer for each pixel, and a gap portion is disposed between the respective pixels.

7. The reflective color conversion color filter according to claim 6, wherein the gap portion is provided with a black matrix.

8. A reflective display device comprising: a first substrate; a second substrate which faces the first substrate and which is positioned on an observer side; a reflective color conversion color filter disposed in such a manner that the reflective layer side is positioned on the surface of the first substrate facing the second substrate; a liquid crystal layer which is disposed between the reflective color conversion color filter and the second substrate to change an oriented state in accordance with an applied voltage; and a pair of polarization layers disposed on first and second substrate sides of the liquid crystal layer, the reflective color conversion color filter comprising: at least a reflective layer; and a color filter layer and a color conversion layer successively stacked on the reflective layer, the color conversion layer being configured to absorb a part of light of a wavelength region absorbed by the color filter layer and to convert the part into light of a wavelength region transmitted by the color filter layer.

9. The reflective display device according to claim 8, wherein the polarization layer disposed on the first substrate side is disposed between the liquid crystal layer and the reflective color conversion color filter.

10. The reflective display device according to claim 8, wherein the color filter layer comprises at least one of a red color filter layer which transmits light of a red wavelength region, a green color filter layer which transmits light of a green wavelength region, and a blue color filter layer which transmits light of a blue wavelength region; the color conversion layer disposed in the red color filter layer is a red conversion layer which absorbs light on a wavelength side shorter than red light and which converts the light into light containing a red component; the color conversion layer disposed in the green color filter layer is a green conversion layer which absorbs light on a wavelength side shorter than green light and which converts the light into light containing a green component; and the color conversion layer disposed in the blue color filter layer is a blue conversion layer which absorbs light on a wavelength side shorter than blue light and which converts the light into light containing a blue component.

11. The reflective display device according to claim 8, wherein the red color filter layer has an average light ray transmission ratio of 10% or less in a wavelength range of 400 to 550 nm, the green color filter layer has an average light ray transmission ratio of 10% or less in a wavelength range of 400 to 450 nm, and an average light ray transmission ratio of 20% or less in a wavelength range of 600 to 700 nm, and the blue color filter layer has an average light ray transmission ratio of 10% or less in a wavelength range of 550 to 700 nm.

12. The reflective display device according to claim 8, wherein the reflective layer is formed into a concave/convex shape on an interface between the reflective layer and the color filter layer.

13. The reflective display device according to claim 8, wherein the reflective layer is a white plate.

14. The reflective display device according to claim 8, wherein the color filter layer and the color conversion layer are stacked on the reflective layer for each pixel, and a gap portion is disposed between the respective pixels.

15. The reflective display device according to claim 14, wherein the gap portion is provided with a black matrix.

16. A reflective display device comprising: a first substrate; a second substrate which faces the first substrate and which is positioned on an observer side; a reflective color conversion color filter disposed in such a manner that the reflective layer side is positioned on the surface of the first substrate facing the second substrate; and a transparent insulating liquid layer disposed between the reflective color conversion color filter and the second substrate and containing particles whose distributed states change in accordance with an applied voltage, the reflective color conversion color filter comprising: at least a reflective layer; and a color filter layer and a color conversion layer successively stacked on the reflective layer, the color conversion layer being configured to absorb a part of light of a wavelength region absorbed by the color filter layer and to convert the part into light of a wavelength region transmitted by the color filter layer.

17. The reflective display device according to claim 16, wherein the color filter layer comprises at least one of a red color filter layer which transmits light of a red wavelength region, a green color filter layer which transmits light of a green wavelength region, and a blue color filter layer which transmits light of a blue wavelength region; the color conversion layer disposed in the red color filter layer is a red conversion layer which absorbs light on a wavelength side shorter than red light and which converts the light into light containing a red component; the color conversion layer disposed in the green color filter layer is a green conversion layer which absorbs light on a wavelength side shorter than green light and which converts the light into light containing a green component; and the color conversion layer disposed in the blue color filter layer is a blue conversion layer which absorbs light on a wavelength side shorter than blue light and which converts the light into light containing a blue component.

18. The reflective display device according to claim 16, wherein the red color filter layer has an average light ray transmission ratio of 10% or less in a wavelength range of 400 to 550 nm, the green color filter layer has an average light ray transmission ratio of 10% or less in a wavelength range of 400 to 450 nm, and an average light ray transmission ratio of 20% or less in a wavelength range of 600 to 700 nm, and the blue color filter layer has an average light ray transmission ratio of 10% or less in a wavelength range of 550 to 700 nm.

19. The reflective display device according to claim 16, wherein the reflective layer is formed into a concave/convex shape on an interface between the reflective layer and the color filter layer.

20. The reflective display device according to claim 16, wherein the reflective layer is a white plate.

21. The reflective display device according to claim 16, wherein the color filter layer and the color conversion layer are stacked on the reflective layer for each pixel, and a gap portion is disposed between the respective pixels.

22. The reflective display device according to claim 21, wherein the gap portion is provided with a black matrix.
